(19) United States
(12) Patent Application Publication
(10) Pub. No.: US 2014/0240247 A1
(43) Pub. Date: Aug. 28, 2014

(54) METHOD FOR PRESENTING A PHOTO GALLERY AND TERMINAL DEVICE THEREOF

(71) Applicant: Xiaomi Inc., Beijing (CN)

(72) Inventors: Fan Jin, Beijing (CN); Yan Wang, Beijing (CN); Jingwei Cai, Beijing (CN); Shen Li, Beijing (CN)

(73) Assignee: Xiaomi Inc., Beijing (CN)

(21) Appl. No.: 14/141,497

(22) Filed: Dec. 27, 2013

Related U.S. Application Data
(63) Continuation-in-part of application No. PCT/CN2013/083486, filed on Sep. 13, 2013.

(30) Foreign Application Priority Data
Feb. 22, 2013 (CN) 201310056645.2

(51) Int. Cl. G06F 3/041; G09G 5/37

(52) U.S. Cl. CPC G06F 3/041; G09G 5/37
USPC 345/173

(57) ABSTRACT

Embodiments of the present disclosure disclose a method for presenting a photo gallery in a terminal device and the terminal device thereof The method may comprise: detecting a sliding path of a touch operation on a screen of a terminal device; and performing an operation on a predetermined area and presenting pictures of the photo gallery according to a photo gallery operation mode to which the sliding path corresponds. When the photo gallery is initiated to display the pictures, the predetermined area may be automatically hidden according to the sliding path generated on the screen of the terminal device by a user, thereby increases display area for the pictures in the photo gallery, reduces the amount of sliding actions for presenting the pictures, saves time taken for processing the pictures, and improves user experience.

### CROSS-REFERENCE TO RELATED APPLICATIONS

This application is a Continuation-In-Part of International Application PCT/CN2013/083486, filed on Sep. 13, 2013, which claims priority from Chinese Patent Application No. 201310056645.2, filed on Feb. 22, 2013, the entire contents of all of which are incorporated herein by reference.

### TECHNICAL FIELD

The present disclosure generally relates to communication technology field, and more particularly, to a method for presenting a photo gallery in a terminal device and the terminal device thereof.

### BACKGROUND

With the rapid development of communication technology, mobile phones have become necessities in daily life and work for most people. Currently, taking pictures with the mobile phones has become a common and popular way of using of the mobile phones. As the storage space of a mobile phone gets larger and larger, the number of pictures stored in the mobile phone can reach several hundreds.

For example, as shown in FIG. 1, after a photo gallery application program in a mobile phone is opened, the total number of the pictures in the photo gallery is displayed in a message display column on the top of a screen of the mobile phone, and the message display columns containing messages such as “Mobile phone photos” and “Cloud album” are displayed at the bottom of the screen of the mobile phone, to allow a user to select and view the pictures stored in different locations.

The message display columns of “Mobile phone photos” and “Cloud album” occupied the space for displaying pictures on the screen of the mobile phone, and only a total of 18 pictures including picture 1 to picture 18 are displayed in the photo gallery. However, there are a total of 434 pictures in the photo gallery and only 18 pictures of them can be displayed each time, thus in order to present the pictures, a person must slide the screen of the mobile phone multiple times to accomplish the displaying.

### SUMMARY

Embodiments of the present application provide a method for presenting a photo gallery in a terminal device and the terminal device thereof. The method and device are used to automatically display or hide a predetermined area, thereby increase display area for pictures of the photo gallery, reduce the number of times of sliding to present the pictures, thus save time taken for processing the pictures, and improve user experience.

According to a first aspect of the present disclosure, a method for presenting a photo gallery in a terminal device comprises: detecting a sliding path of a touch operation on a screen of the terminal device; and performing an operation on a predetermined area and presenting pictures of the photo gallery according to a photo gallery operation mode to which the sliding path corresponds.

According to a second aspect of the present disclosure, a terminal device for presenting a photo gallery comprises: a processor; and a memory for storing instructions executable by the processor; wherein the processor is configured to execute steps comprising: detecting a sliding path of a touch operation on a screen of the terminal device; and performing an operation on a predetermined area and presenting pictures of the photo gallery according to a photo gallery operation mode to which the sliding path corresponds.

According to a third aspect, the present disclosure also provides a non-transitory computer readable storage medium including instructions, executable by a processor in a device, for presenting a photo gallery, comprising: detecting a sliding path of a touch operation on a screen of a terminal device; and performing an operation on a predetermined area and presenting pictures of the photo gallery according to a photo gallery operation mode to which the sliding path corresponds.

Accordingly, when the photo gallery is initiated to display the pictures, the predetermined area may be automatically hidden according to the sliding path generated on the screen of the terminal device by a user, thereby increases display area for the pictures of the photo gallery, reduces the amount of sliding actions for presenting the pictures, saves time taken for processing the pictures, and improves user experience.

### BRIEF DESCRIPTION OF THE DRAWINGS

FIG. 1 is an illustrative diagram of presenting pictures in a photo gallery as mentioned in the prior art.

FIG. 2 is a flowchart of a method for presenting a photo gallery in a terminal device according to an embodiment of the present application.

FIG. 3 is an illustrative diagram of presenting pictures in a photo gallery according to an embodiment of the present application.

FIG. 4 is a flowchart of a method for presenting a photo gallery when sliding upward and downward according to another embodiment of the present application.

FIG. 5 is a flowchart of a method for presenting a photo gallery when sliding left and right according to another embodiment of the present application.

FIG. 6 is a flowchart of a process of determining a photo gallery operation mode to which a sliding path corresponds according to another embodiment of the present application.

FIG. 7 is a block diagram of an apparatus for presenting a photo gallery in a terminal device according to an embodiment of the present application.

Specific embodiments of the present disclosure have been illustrated in the above drawings and the detailed description thereof will be given hereinafter. These drawings and written description are only to illustrate the concept of the present disclosure with reference to the specific embodiments for those skilled in the art rather than limiting the scope conceived by the present disclosure in any manner.

### DETAILED DESCRIPTION

Embodiments of a method for presenting a photo gallery in a terminal device and the terminal device thereof according to the present disclosure will be explained in detail in conjunction with the accompanying drawings. It should be understood that the embodiments described herein are only used to illustrate and explain the present disclosure, but not to limit the present disclosure.

According to the present disclosure, the terminal device may be implemented using a variety of different types of electronic devices. Examples of such electronic devices may include mobile phones, computers, digital broadcast terminals, messaging devices, gaming consoles, tablets, medical devices, exercise equipment, personal digital assistants, and the like.

The terminal device is an electronic device and includes one or more processors to receive various data, programs and instructions, and to process such data, programs and instructions accordingly. The terminal device also includes a memory which is coupled to the one or more processors and is configured to store the data, programs and instructions to be processed by the processors. Furthermore, the terminal device may further include input modules, such as a touch screen, a keyboard, a mouse or the like. The touch screen is configured to provide both an output interface and an input interface between the terminal device and a user. In some embodiments, the touch screen may comprise a liquid crystal display (LCD) and a touch panel (TP). The touch panel includes a plurality of touch sensors to sense touch operations on the touch panel. In certain embodiments of the present disclosure, the “touch operation” comprises a movement from a starting region to an end region along a sliding path. In certain embodiments, the “touch operation” includes a touch on the surface of a terminal device or the screen of the terminal device (e.g., a first starting region) for a certain period of time or with certain pressure.

The terminal device may be provided with an operating system to implement data or instruction processing. The operating system may further include a user interface where interaction between a user and the terminal device occurs. The user interface allows the user to manipulate the operating system of the terminal device via user inputs, and allows the operating system to indicate the effects or reactions of the user's manipulation. The terminal device may be also installed with at least one applications/application programs, including without limitation, a browser application, a photo gallery application, an alarm application, an email application, a camera application, an instant messaging application, a music player application, etc. For example, the user may use a photo gallery application to view one or more pictures.

In the following description, the method for presenting a photo gallery in the terminal device in accordance with some embodiments of the present disclosure is explained. While the process flow described below includes a plurality of steps that appear to occur in a specific order, it should be apparent that those procedures may include either fewer or more operations, which may be executed serially or in parallel.

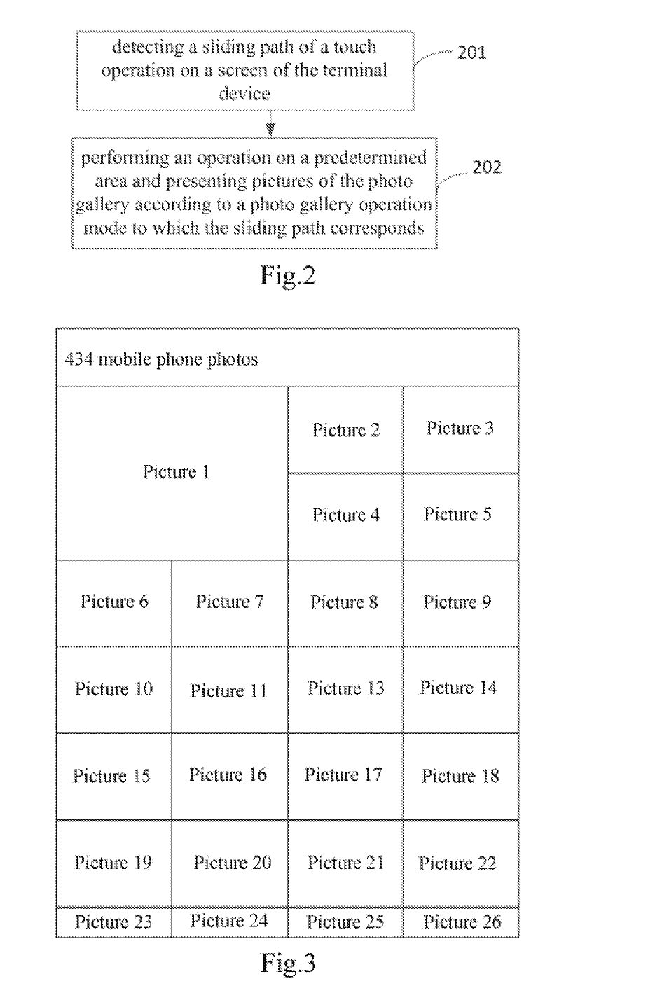

FIG. 2 is a flowchart illustrating an embodiment of the present disclosure provides a method for presenting a photo gallery in a terminal device, such as in a mobile terminal. The method comprises the following steps.

In step 201, the method includes detecting a sliding path of a touch operation on a screen of the terminal device.

In step 202, the method includes performing an operation on a predetermined area and presenting pictures of the photo gallery according to a photo gallery operation mode to which the sliding path corresponds.

In some embodiments, after detecting the sliding path of the touch operation on the screen of the terminal device, the method comprises: determining the photo gallery operation mode to which the sliding path corresponds according to preset nexuses between sliding paths and photo gallery operation modes by the operating system of the terminal device; or determining the photo gallery operation mode to which the sliding path corresponds according to the preset nexuses between sliding paths and photo gallery operation modes by the photo gallery application program installed in the terminal device.

Wherein, the nexuses between the sliding path and the photo gallery operation mode is preset and stored in the terminal device in advance, for example, the photo gallery operation mode to which the sliding path corresponds is an operation mode of hiding a predetermined area such as a message display column in the photo gallery, or an operation mode of displaying the predetermined area in the photo gallery when the sliding path is a path of sliding upward. Thus, the corresponding photo gallery operation mode may be determined according to the nexuses after detection of the sliding path of the touch operation on the screen of the terminal device.

In some embodiments, detecting the sliding path of the touch operation on the screen of the terminal device comprises: detecting a start point and an end point of the touch operation on the screen of the terminal device; and determining a direction and a distance of straight line sliding of the sliding path according to the start point and the end point of the touch operation.

In some embodiments, determining the photo gallery operation mode to which the sliding path corresponds according to the preset nexuses between the sliding paths the and photo gallery operation modes comprises: determining whether the sliding path is valid or not according to the direction and the distance of straight line sliding of the sliding path; performing a search and determining the photo gallery operation mode to which the sliding path corresponds in the preset nexuses between the sliding paths and the photo gallery operation modes when the sliding path is determined to be valid.

In some embodiments, determining whether the sliding path is valid or not according to the direction and the distance of straight line sliding of the sliding path comprises: determining whether the direction and the distance of straight line sliding of the sliding path are within a predetermined range; if yes, determining the sliding path to be valid, and if no, determining the sliding path to be invalid.

In order to prevent mis-operation, a valid range can be preset for the direction of the sliding path. For example, if an angle formed by a straight line between a start point and an end point with respect to a horizontal direction or a vertical direction of a terminal device is within x, then the sliding path is valid. For instance, a predetermined range is 30 degree to 150 degree with respect to a horizontal direction of a mobile phone as reference, if a direction of a sliding path is deviated too much (such as sliding in the horizontal direction), it can not be determined that the sliding path corresponds to a photo gallery operation mode, thus the sliding is invalid. For another instance, the predetermined range is 30 degree to 150 degree with respect to a vertical direction of the mobile phone as reference, if the direction of the sliding path is deviated too much (such as sliding in the vertical direction), it can not be determined that the sliding path corresponds to a photo gallery operation mode, thus the sliding is also invalid. Similarly, in order to prevent mis-operation, a threshold value such as y may also be set for the distance of straight line sliding of the sliding path, and when the distance of straight line sliding is greater than y, it is determined to be a valid operation.

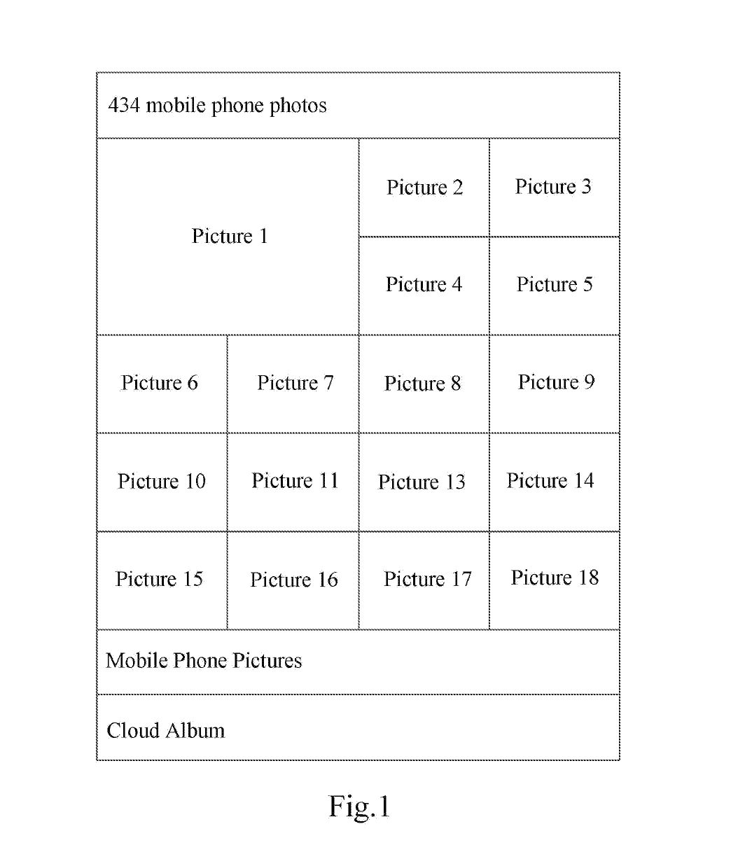

In some embodiments, performing an operation on a predetermined area and presenting pictures of the photo gallery according to a photo gallery operation mode to which the sliding path corresponds comprises: hiding the predetermined area and presenting the pictures of the photo gallery on full screen of the terminal device if the sliding path is a path of sliding upward; and displaying the predetermined area and presenting the pictures of the photo gallery in positions except for the predetermined area on the full screen of the terminal device if the sliding path is a path of sliding downward. As shown in FIG. 3, it is an illustrative diagram of presenting the pictures of the photo gallery after hiding the predetermined area. Compared with FIG. 1, it can be seen that the number of the pictures presented in the photo gallery increased to a total of 26 pictures including picture 1 to picture 26 being displayed, thereby reduces the amount of sliding actions for viewing the pictures, and increases processing efficiency.

It can be seen from the above description, the embodiments of the present application provide a method for presenting a photo gallery, and when the photo gallery is initiated to display the pictures, the predetermined area may be automatically hidden according to the sliding path generated on the screen of the terminal device by a user, thereby increases display area for the pictures in the photo gallery, reduces the amount of sliding actions for presenting the pictures, saves time taken for processing the pictures, and improves user experience.

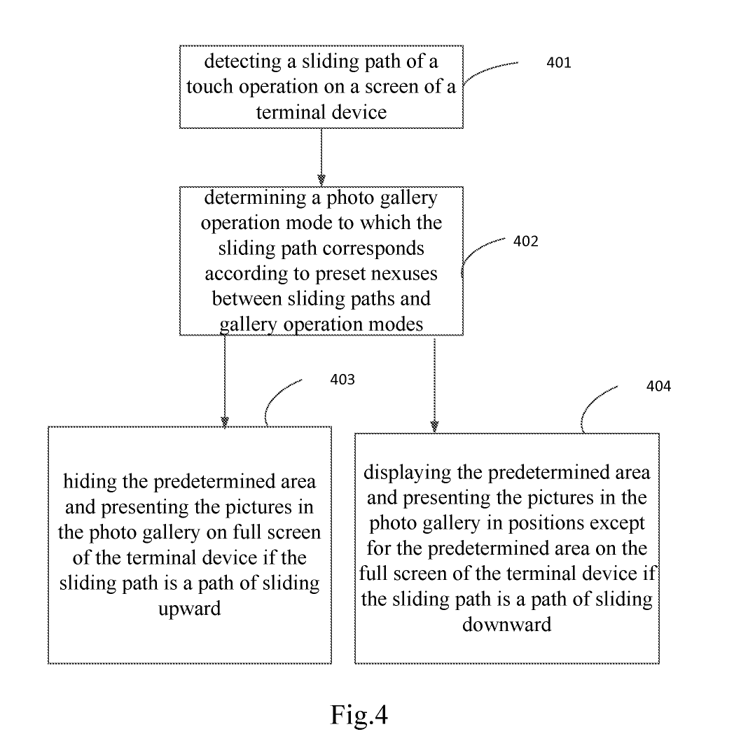

Hereinafter, an embodiment according to the present disclosure will be described in detail with an example of a method of sliding upward to hide a predetermined area, as shown in FIG. 4. The method comprises the following steps.

In step 401, the method includes detecting a sliding path of a touch operation on a screen of a terminal device.

In step 402, the method includes determining a photo gallery operation mode to which the sliding path corresponds according to preset nexuses between sliding paths and gallery operation modes. Wherein a process of determining the nexuses may be processed by the operating system of the terminal device, or the photo gallery application program installed in the terminal device. In case that the photo gallery application program performs the process of determining the nexuses, the photo gallery application program determines the photo gallery operation mode to which the sliding path corresponds according to the preset nexuses between the sliding paths and the photo gallery operation modes.

In step 403, the method includes hiding the predetermined area and presenting the pictures in the photo gallery on full screen of the terminal device if the sliding path is a path of sliding upward; and then the procedure ends.

In step 404, the method further includes displaying the predetermined area and presenting the pictures in the photo gallery in positions except for the predetermined area on the full screen of the terminal device if the sliding path is a path of sliding downward.

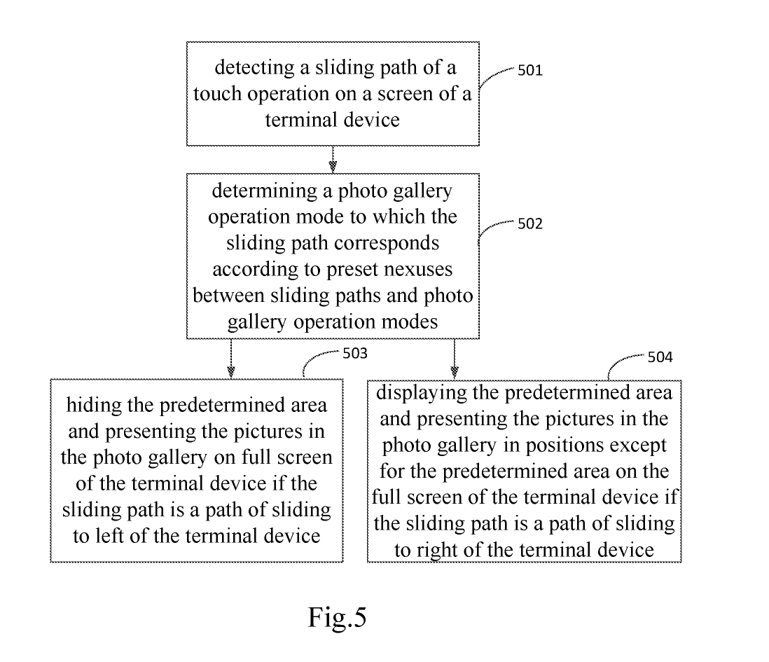

Hereinafter, an embodiment according to the present application will be described in detail with an example of a method of sliding horizontally to hide a predetermined area, as shown in FIG. 5. The method comprises the following steps.

In step 501, the method provides detecting a sliding path of a touch operation on a screen of a terminal device.

In step 502, the method provides determining a photo gallery operation mode to which the sliding path corresponds according to preset nexuses between sliding paths and photo gallery operation modes. Wherein a process of determining the preset nexuses may be processed by the operating system of the terminal device or the photo gallery application program installed in the terminal device. In case that the photo gallery application program performs the process of determining the nexuses, the photo gallery application program determines the photo gallery operation mode to which the sliding path corresponds according to the preset nexuses between the sliding paths and the photo gallery operation modes.

In step 503, the method includes hiding the predetermined area and presenting the pictures in the photo gallery on full screen of the terminal device if the sliding path is a path of sliding to left of the terminal device; and then procedure ends.

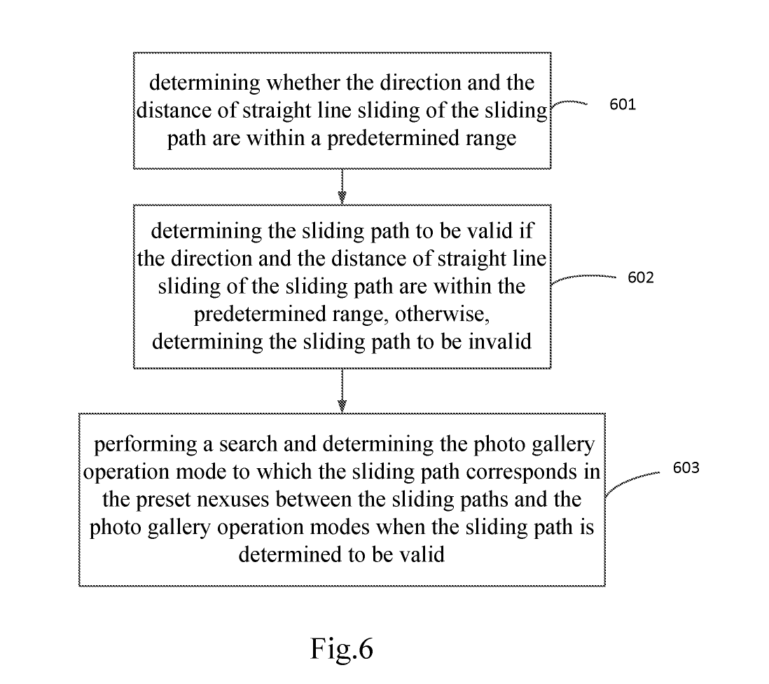

In step 504, the method further includes displaying the predetermined area and presenting the pictures in the photo gallery in positions except for the predetermined area on the full screen of the terminal device if the sliding path is a path of sliding to right of the terminal device.

Wherein, a start point and an end point of the touch operation on the screen of the terminal device may be detected, and a direction and a distance of straight line sliding of the sliding path may be determined according to the start point and the end point of the touch operation. Thus, as shown in FIG. 6, specific implementations of the steps 402 and 502 may comprise the following steps.

Step 601 includes determining whether the direction and the distance of straight line sliding of the sliding path are within a predetermined range.

Step 602 includes determining the sliding path to be valid if the direction and the distance of straight line sliding of the sliding path are within the predetermined range, otherwise, determining the sliding path to be invalid.

Step 603 includes performing a search and determining the photo gallery operation mode to which the sliding path corresponds in the preset nexuses between the sliding paths and the photo gallery operation modes when the sliding path is determined to be valid.

It can be seen from the above description, the embodiments of the present application provide a method for presenting a photo gallery, and when the photo gallery is initiated to display the pictures, the predetermined area may be automatically hidden according to the sliding path generated on the screen of the terminal device by a user, thereby increases display area for the pictures in the photo gallery, reduces the amount of sliding actions for presenting the pictures, saves time taken for processing the pictures, and improves user experience.

Based on the same invention concept, the embodiments of the present application further provide an apparatus for presenting a photo gallery. Since the principle of the apparatus is similar to the above described methods, the implementations of the apparatus may be obtained by referring to the implementations of the methods, and repetition will be omitted.

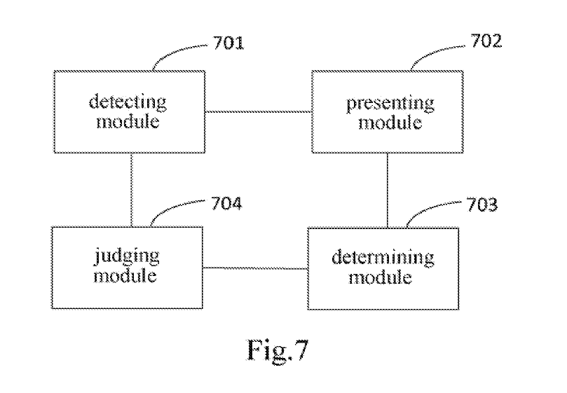

The embodiments of the present disclosure provide an apparatus for presenting a photo gallery in a terminal device, such as a mobile terminal, as shown in FIG. 7, which comprises: a detecting module 701 for detecting a sliding path of a touch operation on a screen of the terminal device; a presenting module 702 for performing an operation on a predetermined area and presenting pictures of a photo gallery according to a photo gallery operation mode to which the sliding path corresponds.

The apparatus further comprises: a determining module 703 for determining the photo gallery operation mode to which the sliding path corresponds according to preset nexuses between sliding paths and photo gallery options by a operating system of the terminal device; or determining the photo gallery operation mode to which the sliding path corresponds according to the preset nexuses between the sliding paths and the photo gallery operation modes by a photo gallery application programs installed in the terminal device.

For example, the detecting module 701 is configured to detect a start point and an end point of the touch operation on the screen of the terminal device, and determine a direction and a distance of straight line sliding of the sliding path according to the start point and the end point of the touch operation.

For example, the determining module 703 is configured to determine whether the sliding path is valid or not according to the direction and the distance of straight line sliding of the sliding path, and perform a search and determine the photo gallery operation mode to which the sliding path corresponds in the preset nexuses between the sliding paths and the photo gallery operation modes when the sliding path is determined to be valid.

The apparatus further comprises: a judging module 704 for determining whether the direction and the distance of straight line sliding of the sliding path are within a predetermined range; if they are within the predetermined range, it determines that the sliding path is valid, and if they are not within the predetermined range, it determines that the sliding path is invalid.

For example, a presenting module 702 is configured to hide the predetermined area and presenting the pictures in the photo gallery on full screen of the terminal device if the sliding path is a path of sliding upward, and display the predetermined area and presenting the pictures in the photo gallery in positions except for the predetermined area on the full screen of the terminal device if the sliding path is a path of sliding downward.

In exemplary embodiments, there is also provided a non-transitory computer readable storage medium including instructions, executable by a processor in the device, for presenting a photo gallery, comprising: detecting a sliding path of a touch operation on a screen of a terminal device; and performing an operation on a predetermined area, and presenting pictures in the photo gallery according to a photo gallery operation mode to which the sliding path corresponds.

When the photo gallery is initiated to display pictures, a predetermined area may be automatically hidden according to a sliding path generated on a screen of a terminal device by a user, thereby increases display area for the pictures in the photo gallery, reduces the amount of sliding actions for presenting the pictures, saves time taken for processing the pictures, and improves user experience.

Through the above description of the embodiments, the skilled persons in the art may clearly understand that the embodiments of present application may be implemented by hardware or by software with necessary general hardware platform. According to this understanding, embodiments of the present application may be technical solutions embodied in forms of software products, and the software products may be stored in a non-transitory storage medium (it may be a CD-ROM, USB disk or mobile hard disk, etc.) which includes computer-executable instructions to enable a terminal device (such as a mobile phone, a personal computer, a server or a network equipment) to perform the method described in various embodiments of the disclosure.

The non-transitory computer readable storage medium may use, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof.

For a software implementation, the embodiments described herein may be implemented with separate software modules, such as procedures and functions, each of which perform one or more of the functions and operations described herein. The software codes can be implemented with a software application written in any suitable programming language and may be stored in memory of the terminal.

The aforementioned methods can be implemented in a non-transitory computer readable storage medium recording computer-readable codes. The non-transitory computer readable storage medium includes all kinds of recording devices in which data readable by a computer system are stored. The non-transitory computer readable storage medium includes ROM, RAM, CD-ROM, magnetic tapes, floppy discs, optical data storage devices, and the like, as well as carrier-wave type implementations (e.g., transmission via Internet).

Persons skilled in the art may understand that the accompanying drawings are just schematic views of preferred embodiments, and the modules or processes shown in the accompanying drawings may not necessarily be implementing this disclosure.

Persons skilled in the art may understand that the modules of the device in the embodiments may be distributed in the device in the embodiments as described in the embodiments, and may also be distributed in one or more devices different from that in the embodiments as corresponding changes. The above modules in the embodiments may be combined into one module, and also may be further split into multiple sub-modules.

The numbers of the above embodiment of the present disclosure are just for description only, and do not represent the advantages and disadvantages of the embodiments.

Obviously, the persons skilled in the art may make various modifications and variations to the disclosure without departing from the intent and scope of this disclosure. Thus, if the modifications and variations to the disclosure are within the scope of the claims of the present disclosure or their equivalents, the present disclosure is intended to cover such modifications and variations.

What is claimed is:

1. A method for presenting a photo gallery in a terminal device, comprising:
detecting a sliding path of a touch operation on a screen of the terminal device; and
performing an operation on a predetermined area and presenting pictures of the photo gallery according to a photo gallery operation mode to which the sliding path corresponds.

2. The method according to claim 1, wherein after detecting the sliding path of the touch operation on the screen of the terminal device, the method further comprises:
determining the photo gallery operation mode to which the sliding path corresponds according to preset nexuses between sliding paths and photo gallery operation modes by a operating system of the terminal device.

3. The method according to claim 1, wherein after detecting the sliding path of the touch operation on the screen of the terminal device, the method further comprises:
determining the photo gallery operation mode to which the sliding path corresponds according to the preset nexuses between the sliding paths and the photo gallery operation modes by a photo gallery application program installed in the terminal device.

4. The method according to claim 1, wherein detecting the sliding path of the touch operation on the screen of the terminal device comprises:
detecting a start point and an end point of the touch operation on the screen of the terminal device; and
determining a direction and a distance of straight line sliding of the sliding path according to the start point and the end point of the touch operation.

5. The method according to claim 4, wherein after detecting the sliding path of the touch operation on the screen of the terminal device, the method further comprises:
determining whether the sliding path is valid or not according to the direction and the distance of straight line sliding of the sliding path; and
performing a search and determining the photo gallery operation mode to which the sliding path corresponds in the preset nexuses between the sliding paths and the photo gallery operation modes when the sliding path is determined to be valid.

6. The method according to claim 5, wherein determining whether the sliding path is valid or not comprises:
determining the sliding path to be valid if the direction and the distance of straight line sliding of the sliding path are within a predetermined range, otherwise, determining the sliding path to be invalid.

7. The method according to claim 1, wherein performing an operation on a predetermined area and presenting pictures of the photo gallery comprises:
hiding the predetermined area and presenting the pictures of the photo gallery on a full screen of the terminal device if the sliding path is a path of sliding upward; and
displaying the predetermined area and presenting the pictures of the photo gallery in positions except for the predetermined area on the full screen of the terminal device if the sliding path is a path of sliding downward.

8. A terminal device for presenting a photo gallery, comprising:
a processor; and
a memory for storing instructions executable by the processor;
wherein the processor is configured to execute steps comprising:
detecting a sliding path of a touch operation on a screen of the terminal device; and
performing an operation on a predetermined area and presenting pictures of the photo gallery according to a photo gallery operation mode to which the sliding path corresponds.

9. The terminal device according to claim 8, wherein the processor is configured to execute the following step after the step of detecting the sliding path of the touch operation on the screen of the terminal device:
determining the photo gallery operation mode to which the sliding path corresponds according to preset nexuses between sliding paths and photo gallery operation modes by a operating system of the terminal device.

10. The terminal device according to claim 8, wherein the processor is configured to execute the following step after the step of detecting the sliding path of the touch operation on the screen of the terminal device:
determining the photo gallery operation mode to which the sliding path corresponds according to the preset nexuses between the sliding paths and the photo gallery operation modes by a photo gallery application program installed in the terminal device.

11. The terminal device according to claim 8, wherein detecting the sliding path of the touch operation on the screen of the terminal device comprises:
detecting a start point and an end point of the touch operation on the screen of the terminal device; and
determining a direction and a distance of straight line sliding of the sliding path according to the start point and the end point of the touch operation.

12. The terminal device according to claim 11, wherein the processor is configured to execute the following step after the step of detecting the sliding path of the touch operation on the screen of the terminal device:
determining whether the sliding path is valid or not according to the direction and the distance of straight line sliding of the sliding path; and
performing a search and determining the photo gallery operation mode to which the sliding path corresponds in the preset nexuses between the sliding paths and the photo gallery operation modes when the sliding path is determined to be valid.

13. The terminal device according to claim 12, wherein determining whether the sliding path is valid or not comprises:
determining the sliding path to be valid if the direction and the distance of straight line sliding of the sliding path are within a predetermined range, otherwise, determining the sliding path to be invalid.

14. The terminal device according to claim 8, wherein performing an operation on a predetermined area and presenting pictures of the photo gallery comprises:
hiding the predetermined area and presenting the pictures of the photo gallery on a full screen of the terminal device if the sliding path is a path of sliding upward; and
displaying the predetermined area and presenting the pictures of the photo gallery in positions except for the predetermined area on the full screen of the terminal device if the sliding path is a path of sliding downward.

15. A non-transitory computer readable storage medium including instructions, executable by a processor in a terminal device, for presenting a photo gallery, comprising:
detecting a sliding path of a touch operation on a screen of the terminal device; and
performing an operation on a predetermined area and presenting pictures of the photo gallery according to a photo gallery operation mode to which the sliding path corresponds.
